(19) United States
(12) Patent Application Publication
(10) Pub. No.: US 2026/0338010 A1
(43) Pub. Date: Oct. 29, 2026

(54) ELECTRONIC LATCH WITH VARIABLE BACKUP RELEASE CONTROL

(71) Applicant: Magna Closures Inc., Newmarket (CA)

(72) Inventors: Francesco CUMBO, Newmarket (CA); Antonio FRELLO, Newmarket (CA); Davide DENTE, Newmarket (CA)

(73) Assignee: Magna Closures Inc., Newmarket (CA)

(21) Appl. No.: 19/658,303

(22) Filed: Apr. 24, 2026

Related U.S. Application Data
(60) Provisional application No. 63/795,668, filed on Apr. 28, 2025.

(51) Int. Cl. E05B 81/86; E05B 81/06; E05B 81/18

(52) U.S. Cl. CPC E05B 81/86; E05B 81/06; E05B 81/18

(57) ABSTRACT

An electronic latch assembly for a closure panel of a motor vehicle includes an actuator group operable to control latching and unlatching of the closure panel. The actuator group includes an electric motor controllable to drive the actuator group. The electric motor is supplied, during a normal operating condition, by a main power source of the motor vehicle providing a main supply voltage. The electronic latch assembly additionally includes a backup energy source having a backup supply voltage for supplying power to the electronic latch assembly during a failure operating condition different from the normal operating condition. The electronic latch assembly also includes a control unit configured to supply a power release voltage to the electric motor to unlatch the closure panel. The power release voltage is adjusted to different levels.

### CROSS-REFERENCE TO RELATED APPLICATION

This utility application claims the benefit of U.S. Provisional Application No. 63/795,668 filed Apr. 28, 2025. The entire disclosure of the above application is incorporated herein by reference.

### FIELD

The present invention relates to an electronic latch (commonly known as an e-latch) of a motor vehicle closure panel, provided with a backup energy source.

### BACKGROUND

This section provides background information related to the present disclosure which is not necessarily prior art.

It is known that electrical latches are provided in motor vehicles, for example for controlling opening and closing of the side doors.

An electrical door latch generally includes a ratchet that is selectively rotatable with respect to a striker fixed to a door post, in order to latch and unlatch the door. The electrical door latch includes a pawl that selectively engages the ratchet to prevent the ratchet from rotating. The electrical door latch includes an electric motor, which is electrically connected to a main electric power supply of the vehicle (for example to the 12V battery of the same vehicle), in order to directly or indirectly drive the pawl, via an electrically-operated actuator.

As it is known, a common problem related to electrical latches is that of controlling, as it is also required by security regulations, opening and closing of the doors even in case of failure of the main power supply of the vehicle, or in case of interruptions or breaking of the electrical connection between the main power supply and the electric motor in the latch; this kind of situation may occur for example in case of an accident or crash involving the vehicle.

A possible solution to this problem envisages the use of a mechanical release mechanism in the latch, which serves as a manual backup to the electrically activated side door latch.

However, the presence of a redundant mechanical mechanism entails higher area occupation and weight and additional costs, and also represents a further constriction for designing the door.

Therefore, the use of a backup power source for the electrical latch has been proposed, in order to supply electrical energy to the electric motor of the latch, in case of failure or interruption of the vehicle main power supply.

This backup power source is usually kept in a charged state during normal operation, by the main power supply, so as to be readily available as soon as the need arises, for example in case of a crash or accident.

However, designing of a backup power source, and of the related electronic circuitry, for the electric latch assembly has proven to be a difficult task, for example due to size requirements, as also has proven to be difficult meeting desired electrical performance, for example in terms of energy density or current output, especially in automotive operating conditions.

In this respect, EP 0 694 664 A1 discloses a backup energy source for a door latch, designed to supply power to the latch during emergency situations, which envisages an auxiliary battery arranged within the door where the latch is placed.

Another known solution, discussed in DE 201 21 915 U1, discloses the use of a capacitor group as a backup power source for a vehicle door latch. The capacitor group is coupled to a circuit board, externally connected to the latch assembly. The capacitor group includes a vast number of capacitors, of the high voltage type (withstanding up to V), series or parallel connected, thus requiring a relevant amount of space on the circuit board; moreover, such solution generally needs a further backup energy source, since the supercapacitor group may only be able to supply power for a limited amount of time. In other words, the capacitor group may not be able to guarantee a sufficient and autonomous backup energy source for the vehicle latch.

In view of the above, there remains a need to develop electronic latches which address and overcome limitations and drawbacks associated with known electronic latches as well as to provide increased convenience and enhanced operational capabilities.

### SUMMARY

This section provides a general summary of the disclosure, and is not a comprehensive disclosure of its full scope or all of its features.

It is an object of the present disclosure to provide an electronic latch assembly for a closure panel of a motor vehicle. The electronic latch assembly includes an actuator group operable to control latching and unlatching of the closure panel and including an electric motor controllable to drive the actuator group. The electric motor is supplied, during a normal operating condition, by a main power source of the motor vehicle providing a main supply voltage. The electronic latch assembly additionally includes a backup energy source having a backup supply voltage for supplying power to the electronic latch assembly during a failure operating condition different from the normal operating condition. The electronic latch assembly also includes a control unit configured to supply a power release voltage to the electric motor to unlatch the closure panel. The power release voltage is adjusted to different levels.

In another aspect, the power release voltage is adjusted based on characteristics of the backup energy source.

In another aspect, the characteristics of the backup energy source include the backup supply voltage and the control unit is further configured to adjust the power release voltage based the backup supply voltage.

In another aspect, the characteristics of the backup energy source include a backup supply capacitance and the control unit is further configured to adjust the power release voltage based the backup supply capacitance.

In another aspect, the power release voltage is adjusted based on the unlatching being completed.

In another aspect, the power release voltage includes a first power release voltage and a second power release voltage greater than the first power release voltage and the control unit is further configured to receive a request for unlatching during the failure operating condition. The control unit is also configured to determine whether a backup energy level of the backup energy source is greater than a required energy threshold level. In addition, the control unit is configured to supply the second power release voltage to the electric motor to unlatch the closure panel in response to determining the backup energy level of the backup energy source is not greater than the required energy threshold level. The control unit ends the unlatching after supplying the second power release voltage to the electric motor to unlatch the closure panel. The control unit is further configured to supply the first power release voltage to the electric motor to unlatch the closure panel in response to determining the backup energy level of the backup energy source is greater than the required energy threshold level. The control unit is additionally configured to determine whether the unlatching of the closure panel is completed using the first power release voltage. The control unit ends the unlatching in response to determining the unlatching is completed using the first power release voltage. In addition, the control unit is configured to supply the second power release voltage to the electric motor to unlatch the closure panel in response to determining the unlatching is not completed using the first power release voltage. The control unit is also configured to end the unlatching.

In another aspect, the required energy threshold level is based on at least one of the backup supply voltage of the backup energy source or abackup supply capacitance of the backup energy source.

According to another aspect, a method of operating an electronic latch assembly for a closure panel of a motor vehicle is provided. The method includes the step of supplying power to the electronic latch assembly using a backup energy source having a backup supply voltage during a failure operating condition different from a normal operating condition, an electric motor controllable to drive an actuator group to latching and unlatching of the closure panel being supplied by a main power source of the motor vehicle providing a main supply voltage in the normal operating condition. The method also includes the step of supplying a power release voltage to the electric motor to unlatch the closure panel, the power release voltage adjusted to different levels.

In another aspect, the power release voltage is adjusted based on characteristics of the backup energy source.

In another aspect, the characteristics of the backup energy source 20 include the backup supply voltage and the method further includes the step of adjusting the power release voltage based the backup supply voltage.

In another aspect, the characteristics of the backup energy source include a backup supply capacitance and the method further includes the step of adjusting the power release voltage based the backup supply capacitance.

In another aspect, the power release voltage includes a first power release voltage and a second power release voltage greater than the first power release voltage and the method further includes the step of supplying the first power release voltage to the electric motor to unlatch the closure panel. The method additionally includes the step of determining whether the unlatching of the closure panel is completed using the first power release voltage. The method also includes the step of supplying the second power release voltage to the electric motor to unlatch the closure panel in response to determining the unlatching is not completed using the first power release voltage.

In another aspect, the second power release voltage is a maximum power release voltage that the backup energy source is capable of providing.

In another aspect, the power release voltage includes a first power release voltage and a maximum power release voltage the backup energy source is capable of providing and the method further includes the step of determining whether the backup energy source is capable of supplying the electric motor for a predetermined quantity of unlatching attempts. The method also includes the step of supplying the electric motor with the maximum power release voltage in response to determining the backup energy source is not capable of supplying the electric motor for the predetermined quantity of unlatching attempts.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic representation of a motor vehicle with a closure panel and a related electronic latch assembly according to aspects of the disclosure;

FIG. 2 is a general block diagram of an electronic control circuit of the electronic latch assembly of FIG. 1 according to aspects of the disclosure; and

FIGS. 3 and 4 illustrate steps of a method of operating an electronic latch assembly according to aspects of the disclosure.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

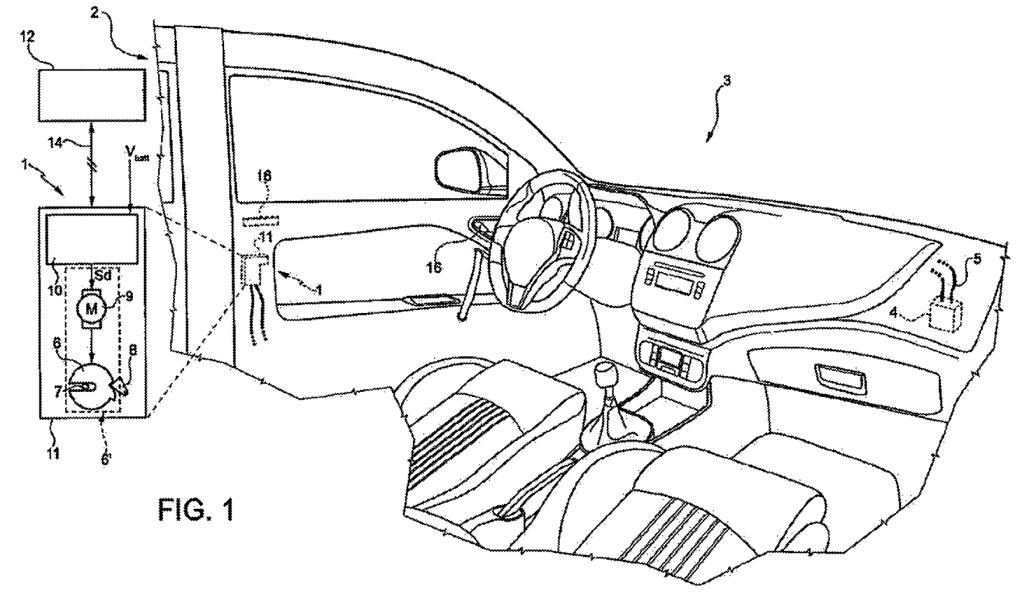

Number 1 in FIG. 1 indicates as a whole an electronic latch assembly (e-latch assembly 1), coupled to a side door 2 of a motor vehicle 3 (however, it should be understood that the electronic latch assembly 1 may equally be coupled to any kind of closure panel of the motor vehicle 3).

The electronic latch assembly 1 is electrically connected to a main power source 5 of the motor vehicle 3, for example a main battery providing a battery voltage V_{batt}of 12 V, through an electrical connection element 5, for example a power cable (the main power source 4 may equally include a different source of electrical energy within the motor vehicle 3, for example an alternator).

The electronic latch assembly 1 includes an actuation group 6′, including an electric motor, operable to control actuation of the door 2 (or in general of the vehicle closure panel).

In a possible embodiment, the actuation group 6′ includes a ratchet 6, which is selectively rotatable to engage a striker 7 (fixed to the body of the motor vehicle 3, for example to the so called “A pillar” or “B pillar”, in a manner not shown in detail). When the ratchet 6 is rotated into a latching position with respect to the striker 7, the side door 2 is in a closed operating state. A pawl 8 selectively engages the ratchet 6 to prevent it from rotating, driven by an electric motor 9 so as to move between an engaged position and a non-engaged position.

The electronic latch assembly 1 further includes an electronic control circuit 10, for example including a microcontroller or other known computing unit, which may be conveniently embedded and arranged in a same housing or case 11 (shown schematically) with the actuation group 6′ of the electronic latch assembly 1, thus providing an integrated compact and easy-to-assemble unit.

The electronic control circuit 10, as will be shown in more detail in the following, is coupled to the electric motor 9 and provides driving signals S_{d} thereto.

The electronic control circuit 10 is electrically coupled to a vehicle main management unit (also known as main ECU or “vehicle body computer”) 12, which is configured to control general operation of the motor vehicle 3, via a data bus 14, so as to exchange signals, data, commands and/or information.

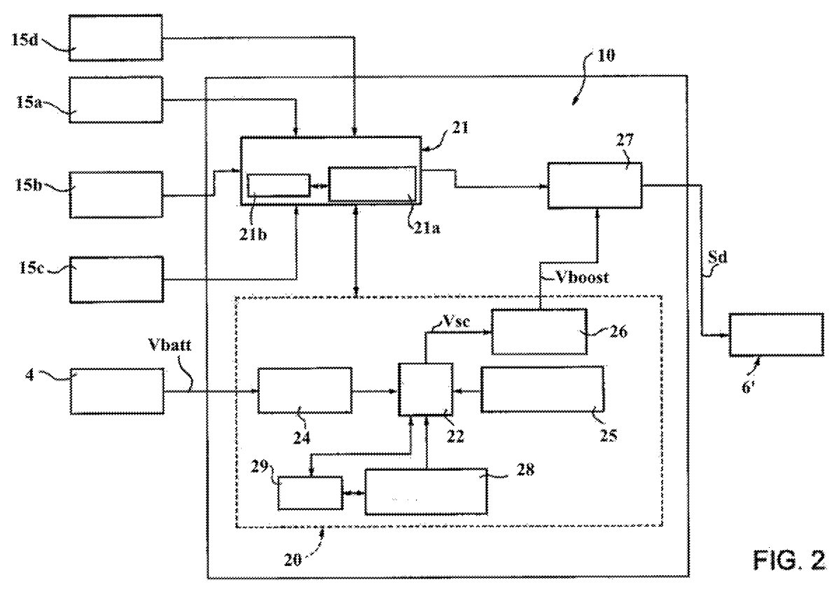

Moreover, as shown also in FIG. 2, the electronic control circuit 10 is (directly, and/or indirectly via the vehicle management unit 12) coupled to several different sensors 15 (shown schematically) of the motor vehicle 3, such as: handle-reading sensors 15 a (which read actuation of external and/or internal handles 16), crash sensors 15 b, lock switch sensors 15 c, and the like; conveniently, the electronic control circuit 10 also receives feedback information about the latch actuation from position sensors 15 d, such as Hall sensors, configured to detect the operating position, for example of the ratchet 6 and/or pawl 8.

The electronic control circuit 10 is also coupled to the main power source 4 of the motor vehicle 3, so as to receive the battery voltage V_{batt}; the electronic control circuit 10 is thus able to check if the value of the battery voltage V_{batt}decreases below a predetermined threshold value, to promptly determine if an emergency condition (when a backup energy source may be needed) occurs.

As shown in the schematic block diagram of FIG. 2, the electronic control circuit 10 includes an embedded and integrated backup energy source 20, which is configured to supply electrical energy to the actuation group 6′ and latch electric motor 9, and to the same electronic control circuit 10, in case of failure or interruption of the main power supply from the main power source 4 of the motor vehicle 3 (e.g., during a crash or emergency condition).

In more detail, the electronic control circuit 10 includes a control unit 21, for example provided with a microcontroller, microprocessor or analogous computing module 21 a, coupled to the backup energy source 20 and the actuation group 6 of the electronic latch assembly 1, to control their operation.

The control unit 21 has an embedded memory 21 b, for example a non-volatile random access memory, coupled to the computing module 21 a, storing suitable programs and computer instructions (for example in the form of a firmware). It is recognized that the control unit 21 may alternatively comprise a logical circuit of discrete components to carry out the functions of the computing module 21 a and memory 21 b.

According to an aspect of the present solution, the backup energy source 20 includes a group of low voltage supercapacitors 22 (hereinafter supercap group 22), as an energy supply unit (or energy tank) to provide power backup to the electronic latch assembly 1, even in case of power failures. Supercapacitors may include electrolytic double layer capacitors, pseudocapacitors or a combination thereof.

Supercapacitors advantageously provide high energy density, high output current capability and have no memory effects; moreover, supercapacitors have small size and are easy to integrate, have extended temperature range, long lifetime and may withstand a very high number of charging cycles. Supercapacitors are not toxic and do not entail explosive or fire risks, thus being suited for hazardous conditions, such as for automotive applications.

As will be discussed in more detail hereinafter, the backup energy source 20 further includes a charge module 24; an equalization module 25 and a boost module 26.

The charge module 24 is electrically coupled to the supercap group 22 and is configured to recharge, starting from the battery voltage V_{batt}, whenever power from the main power source 4 is available, the supercap group 22, so that the same supercap group 22 may offer a full energy storage for emergency situations and any leakage currents are compensated.

The equalization module 25 is electrically coupled to the supercap group 22, and is configured to ensure that each of the supercapacitor cells have a desired cell voltage value, in particular a same cell voltage value during operation (to achieve a balanced operating condition). The equalization module 25 also avoids that supercapacitor cells have a cell voltage over a maximum desired cell voltage level, protecting the supercapacitors against overcharging.

The boost module 26 receives at its input the backup supply voltage V_{sc} generated by the supercap group 22, and is configured to boost, that is to increase, its value up to automotive standard voltages (for example 9 V-16 V), and to provide enough output current capability to drive standard automotive electric motors, such as the electric motor 9 of the electronic latch assembly 1. Indeed, the backup supply voltage V_{sc}may be too low to provide an effective back-up power source to directly drive the electric motor 9 in emergency situations, like lost or insufficient power supply from main power source 4 of the motor vehicle 3.

The boost module 26 thus provides at its output (that is also the output of the backup energy source 20) a boosted voltage V_{boost}, as a function of the backup supply voltage V_{sc}. The boosted voltage V_{boost} is then received by an output module of the electronic control circuit 10, for example including an integrated H-bridge module 27, whose output drives the electric motor 9 of the electronic latch assembly 1.

The backup energy source 20 further includes a diagnostic module 28, which is operatively coupled to the supercap group 22 and is configured to monitor the health status of the supercapacitors during the charging process and based on the same charging process, by measuring their voltage value, capacitance value, and internal equivalent resistance (DCR—Direct Current Resistance), again as will be discussed hereinafter.

A temperature sensor 29 is configured to monitor the operating temperature of the supercap group 22, and it is coupled to the diagnostic module 28 to provide the detected temperature information; for example, temperature sensor 29 may include an NTC (Negative Temperature Coefficient) resistor arranged in the proximity of the supercap group 22.

The diagnostic module 28 is operatively coupled to the control unit 21, to provide diagnostic information thereto, for example including the value of the backup supply voltage V_{sc}. In a possible embodiment, not shown, the diagnostic module 28 may be implemented in the control unit 21, as a diagnostic routine run by the microprocessor or microcontroller thereof.

Still referring to FIGS. 1 and 2 and as discussed, the electronic latch assembly 1 includes the actuator group 6’ operable to control latching and unlatching of the closure panel 2. The actuator group 6’ includes the electric motor 9 controllable to drive the actuator group 6’. The electric motor 9 is supplied, during a normal operating condition, by the main power source 5 of the motor vehicle 3 providing the main supply voltage V_{batt}. Again, the electronic latch assembly 1 additionally includes the backup energy source 20 having the backup supply voltage V_{sc}. Thebackup energy source 20 supplies power to the electronic latch assembly 1 during a failure operating condition different from the normal operating condition. The control unit 21 of the electronic latch assembly 1 is configured to supply a power release voltage to the electric motor 9 to unlatch the closure panel 2 (i.e., power release).

Such a failure operating condition or emergency mode can occur in different conditions. For example, if the main power source 5 of the motor vehicle 3 is down or not available, but there is no damage to the motor vehicle 1 from a crash, an expected seal load of the closure panel 2 would be nominal (e.g., 400N). In contrast, after a crash, the seal load could be increased due to the crash (e.g., 5KN). The increased or high seal load results in greater energy being required to unlatch or perform a power release operation of the electronic latch assembly 1. In some cases, the electronic latch assembly 1 performs a power release in the emergency mode at a voltage able to open with a seal load of 5KN, which is inefficient in the case of the nominal load.

Accordingly, the control unit 21 described herein is configured to adjust the power release voltage to different levels. In other words, the controller or control unit 21 is configured to control the release mode to deliver different energy levels to the electric motor 9. In more detail and according to aspects of the disclosure, the power release voltage is adjusted based on characteristics of the backup energy source 20. Such characteristics of the backup energy source 20 can include the backup supply voltage V_{sc} (e.g., measured by the diagnostic module 28) and the control unit 21 is further configured to adjust the power release voltage based the backup supply voltage V_{sc}. Alternatively, or in addition, the characteristics of the backup energy source 20 include a backup supply capacitance (i.e., capacitance value of the supercap group 22, measured by the diagnostic module 28) and the control unit 21 is further configured to adjust the power release voltage based the backup supply capacitance.

According to other aspects, the power release voltage is adjusted based on the unlatching or power release being completed (e.g., a detected by the position sensors 15d). The power release voltage can be initially chosen to be based on the nominal seal load to save energy in conditions in which the battery or main power source 5 of the motor vehicle 3 is unavailable, but there is no damage to the motor vehicle 3 causing a higher seal load. So, the power release voltage can include a first power release voltage (e.g., for the nominal seal load) and a second power release voltage (e.g., for the high seal load) greater than the first power release voltage. Thus, the control unit 21 is further configured to supply the first power release voltage to the electric motor 9 to unlatch the closure panel 2. The control unit 21 is additionally configured to determine whether the unlatching of the closure panel 2 is completed using the first power release voltage. The control unit 21 is also configured to supply the second power release voltage to the electric motor 9 to unlatch the closure panel 2 in response to determining the unlatching is not completed using the first power release voltage. In more detail and according to an aspect, the second power release voltage is a maximum power release voltage that the backup energy source 20 is capable of providing (i.e., a maximum level that the backup energy source 20 is able to supply).

So, in operation, if the release actuation or unlatching is not completed during the emergency situation, the control unit 21 can assume the load is not nominal and retry with the second or full voltage to cover the post-crash condition resulting in the high seal load. The control unit 21 supplies the first level of energy (i.e., the first power release voltage) from the backup energy source 20 to the electric motor 9 to release the latch 1. The control unit 21 then determines if a release is not detected to occur and supplies the second level (i.e., the second power release voltage), higher than the first level of energy to the electric motor 9.

According to further aspects of the disclosure, the control unit 21 is configured to determine whether the backup energy source 20 is capable of supplying the electric motor 9 for a predetermined quantity (e.g., two or more) of unlatching attempts. The control unit 21 is also configured to supply the electric motor 9 with the maximum power release voltage in response to determining the backup energy source 20 is not capable of supplying the electric motor 9 for the predetermined quantity of unlatching attempts. Therefore, during an emergency situation, the control unit 21 is configured to determine if the backup energy source 20 is able to supply power to the electric motor 9 at least the predetermined quantity of power release attempts, and if not, the control unit 21 is configured to supply a maximum level that the backup energy source 20 is able to supply to power the electric motor 9.

According to other aspects, the control unit 21 is further configured to receive a request for unlatching during the failure operating condition. The control unit 21 determines whether a backup energy level (SC energy) of the backup energy source 20 is greater than a required energy threshold level EnergyTH. So, in the case described above when the stored energy of the backup energy source 20 would not be sufficient to guarantee the possibility to actuate the electric motor 9 the for the predetermined quantity of unlatching attempts (e.g., 2 times), the release shall be directly actuated at the maximum voltage assuming the possibility that the seal load is high. The control unit 21 is additionally configured to supply the second power release voltage to the electric motor 9 to unlatch the closure panel 2 in response to determining the backup energy level of the backup energy source 20 is not greater than the required energy threshold level EnergyTH. In addition, the control unit 21 is configured to end the unlatching after supplying the second power release voltage to the electric motor 9 to unlatch the closure panel 2. The control unit 21 supplies the first power release voltage to the electric motor 9 to unlatch the closure panel 2 in response to determining the backup energy level of the backup energy source 20 is greater than the required energy threshold level EnergyTH. Furthermore, the control unit 21 is configured to determine whether the unlatching of the closure panel 2 is completed using the first power release voltage and end the unlatching in response to determining the unlatching is completed using the first power release voltage. The control unit 21 supplies the second power release voltage to the electric motor 9 to unlatch the closure panel 2 in response to determining the unlatching is not completed using the first power release voltage and ends the unlatching.

In more detail and according to an aspect, the required energy threshold level EnergyTH is based on at least one of the backup supply voltage V_{sc}of the backup energy source 20 or abackup supply capacitance of the backup energy source 20. So, the required energy threshold level EnergyTH can be based on backup supply voltage V_{sc}or based on capacitance measurements (to estimate the energy stored in the backup energy source 20).

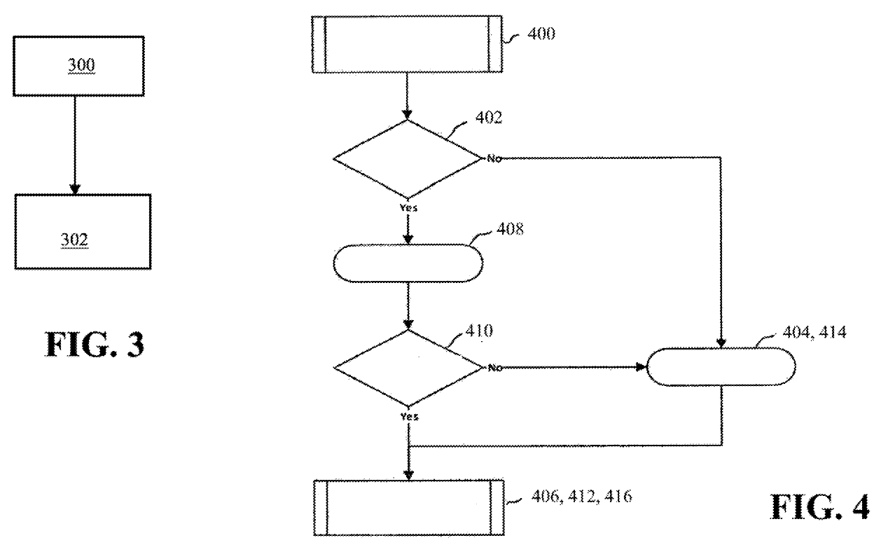

FIGS. 3 and 4 illustrate steps of a method of operating the electronic latch assembly 1. Referring initially to FIG. 3, the method includes the step of 300 supplying power to the electronic latch assembly 1 using a backup energy source 20 having a backup supply voltage V_{sc} during a failure operating condition different from a normal operating condition, an electric motor 9 controllable to drive an actuator group 6’ to latching and unlatching of the closure panel 2 being supplied by a main power source 5 of the motor vehicle 3 providing a main supply voltage V_{batt} in the normal operating condition. The method also includes the step of 302 supplying a power release voltage to the electric motor 9 to unlatch the closure panel 2, the power release voltage adjusted to different levels.

Again, the power release voltage may be adjusted based on characteristics of the backup energy source 20. As discussed, these characteristics can include the backup supply voltage V_{sc}and the method further includes the step of adjusting the power release voltage based the backup supply voltage V_{sc}. Instead, or in addition, the characteristics of the backup energy source 20 include a backup supply capacitance (i.e., capacitance of the supercap group 22) and the method further includes the step of adjusting the power release voltage based the backup supply capacitance.

As above and according to additional aspects of the disclosure, the power release voltage is adjusted based on the unlatching or power release being completed (e.g., a detected by the position sensors 15d). The power release voltage can include a first power release voltage (e.g., for the nominal seal load) and a second power release voltage (e.g., for the high seal load) greater than the first power release voltage. Therefore, the method further includes the step of supplying the first power release voltage to the electric motor 9 to unlatch the closure panel 2. The method additionally includes the step of determining whether the unlatching of the closure panel 2 is completed using the first power release voltage. In addition, the method includes the step of supplying the second power release voltage to the electric motor 9 to unlatch the closure panel 2 in response to determining the unlatching is not completed using the first power release voltage. Again, according to an aspect, the second power release voltage is a maximum power release voltage that the backup energy source 20 is capable of providing. The power release voltage may be adjusted based on the what the energy level in the backup energy source 20 remains stored. The power release voltage may be adjusted based on how many previous power release tries have been attempted. The power release voltage is adjusted based on the temperature of the latch. The power release voltage may be adjusted based on the age of the backup energy source 20. The power release voltage may be adjusted based on the number of cycles of charging and/or discharging having been completed of the backup energy source 20. The power release voltage may be adjusted based on a combination of various states as mentioned above, and others. According to further aspects of the disclosure, the method includes the step of determining whether the backup energy source 20 is capable of supplying the electric motor 9 for a predetermined quantity of unlatching attempts. The method also includes the step of supplying the electric motor 9 with the maximum power release voltage in response to determining the backup energy source 20 is not capable of supplying the electric motor 9 for the predetermined quantity of unlatching attempts.

Now referring specifically to FIG. 4 and according to other aspects of the disclosure, the method further includes the step of 400 receiving a request for unlatching during the failure operating condition. Next, 402 determining whether a backup energy level (SC energy) of the backup energy source 20 is greater than a required energy threshold level EnergyTH. The method proceeds with the step of 404 supplying the second power release voltage to the electric motor 9 to unlatch the closure panel 2 in response to determining the backup energy level of the backup energy source 20 is not greater than the required energy threshold level EnergyTH. The next step of the method is 406 ending the unlatching after supplying the second power release voltage to the electric motor 9 to unlatch the closure panel 2. The method additionally includes the step of 408 supplying the first power release voltage to the electric motor 9 to unlatch the closure panel 2 in response to determining the backup energy level of the backup energy source 20 is greater than the required energy threshold level EnergyTH. The method continues with the step of 410 determining whether the unlatching of the closure panel 2 is completed using the first power release voltage. In addition, the method includes the step of 412 ending the unlatching in response to determining the unlatching is completed using the first power release voltage. The next step of the method is 414 supplying the second power release voltage to the electric motor 9 to unlatch the closure panel 2 in response to determining the unlatching is not completed using the first power release voltage. The method also includes the step of 416 ending the unlatching.

As discussed above and according to an aspect, the required energy threshold level EnergyTH is based on at least one of the backup supply voltage V_{sc}of the backup energy source 20 or abackup supply capacitance of the backup energy source 20.

The term “controller” or “control unit” as used in this application is comprehensive of any computer, processor, microchip processor, integrated circuit, or any other element(s), whether singly or in multiple parts, capable of carrying programming for performing the functions specified in the claims and this written description. The controller, which also be at least one controller, may be a single such element which is resident on a printed circuit board with the other elements the door motion controlling system. It may, alternatively, reside remotely from the other elements of door motion controlling system. For example, but without limitation, the at least one controller may take the form of programming in the onboard computer of a vehicle, such as Body Control Module (“BCM”) comprising the partial portions or entire portions of the door motion controlling system. The controller may also reside in multiple locations or comprise multiple components within the vehicle, including within a vehicle door. For instance, and without limitation, it is contemplated that certain aspects of the controller, such as, by way of non-limiting example, determining a target output torque, may be carried out by a first microprocessor, circuit, etc. which is disposed part of a centralized vehicle or door control system, while other aspects, such as (again by way of non-limiting example) modifying a target current to compensate for irregularities of the power actuator, may be carried out by a second microprocessor, circuit, etc. (such as, for instance, the integrated microprocessor of the power actuator assembly the access system is included).

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects. In either of such forms, all may generally be referred to herein as a “circuit,” “module”, “unit” or “system.” Furthermore, the present disclosure may take the form of a computer program product on a computer-usable storage medium or memory system having computer-usable program code embodied in the medium and constructed as a software product.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations through execution of instructions of the present disclosure may be written in an object oriented programming language such as Java, Python, C++ or the like. The computer program code for carrying out operations of the present disclosure may also be written in conventional procedural programming languages, such as the “C” programming language or similar programming languages. The program code may execute entirely on the one computing device, partly on one computing device, as a stand-alone software package, partly on one local computing device and partly on a remote computing device or entirely on the remote computing device. In the latter scenario, the remote computing device may be connected to the local computing device through a local area network/a wide area network/the Internet, such as via ethernet connection as one example.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions, electronic circuits, hardware, software, or a combination of these, in accordance with non-limiting examples. Computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks. Computer program instructions may be embodied as a computer program or a computer code in a programming language, such as source code, or compiled code.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or a micro processing device or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms "a,” "an," and "the" may be intended to include the plural forms as well, unless the context clearly indicates otherwise. The terms "comprises," "comprising," “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being "on," “engaged to,” "connected to," or "coupled to" another element or layer, it may be directly on, engaged, connected or coupled to the other element or layer, or intervening elements or layers may be present. In contrast, when an element is referred to as being "directly on," “directly engaged to,” "directly connected to," or "directly coupled to" another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term "and/or" includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” "beneath," "below," "lower," "above," "upper," and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as "below" or "beneath" other elements or features would then be oriented "above" the other elements or features. Thus, the example term "below" can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electronic latch assembly for a closure panel of a motor vehicle, including:
an actuator group operable to control latching and unlatching of the closure panel and including an electric motor controllable to drive the actuator group, the electric motor supplied, during a normal operating condition, by a main power source of the motor vehicle providing a main supply voltage;
a backup energy source having a backup supply voltage for supplying power to the electronic latch assembly during a failure operating condition different from the normal operating condition; and
a control unit configured to supply a power release voltage to the electric motor to unlatch the closure panel, the power release voltage adjusted to different levels.

2. The electronic latch assembly of claim 1, wherein the power release voltage is adjusted based on characteristics of the backup energy source.

3. The electronic latch assembly of claim 2, wherein the characteristics of the backup energy source include the backup supply voltage and the control unit is further configured to adjust the power release voltage based the backup supply voltage.

4. The electronic latch assembly of claim 2, wherein the characteristics of the backup energy source include a backup supply capacitance and the control unit is further configured to adjust the power release voltage based the backup supply capacitance.

5. The electronic latch assembly of claim 1, wherein the power release voltage is adjusted based on the unlatching being completed.

6. The electronic latch assembly of claim 1, wherein the power release voltage includes a first power release voltage and a second power release voltage greater than the first power release voltage and the control unit is further configured to:
supply the first power release voltage to the electric motor to unlatch the closure panel;
determine whether the unlatching of the closure panel is completed using the first power release voltage; and
supply the second power release voltage to the electric motor to unlatch the closure panel in response to determining the unlatching is not completed using the first power release voltage.

7. The electronic latch assembly of claim 6, wherein the second power release voltage is a maximum power release voltage that the backup energy source is capable of providing.

8. The electronic latch assembly of claim 1, wherein the power release voltage includes a first power release voltage and a maximum power release voltage the backup energy source is capable of providing and the control unit is further configured to:
determine whether the backup energy source is capable of supplying the electric motor for a predetermined quantity of unlatching attempts; and
supply the electric motor with the maximum power release voltage in response to determining the backup energy source is not capable of supplying the electric motor for the predetermined quantity of unlatching attempts.

9. The electronic latch assembly of claim 1, wherein the power release voltage includes a first power release voltage and a second power release voltage greater than the first power release voltage and the control unit is further configured to:
receive a request for unlatching during the failure operating condition;
determine whether a backup energy level of the backup energy source is greater than a required energy threshold level;
supply the second power release voltage to the electric motor to unlatch the closure panel in response to determining the backup energy level of the backup energy source is not greater than the required energy threshold level;
end the unlatching after supplying the second power release voltage to the electric motor to unlatch the closure panel;
supply the first power release voltage to the electric motor to unlatch the closure panel in response to determining the backup energy level of the backup energy source is greater than the required energy threshold level;
determine whether the unlatching of the closure panel is completed using the first power release voltage;
end the unlatching in response to determining the unlatching is completed using the first power release voltage;
supply the second power release voltage to the electric motor to unlatch the closure panel in response to determining the unlatching is not completed using the first power release voltage; and
end the unlatching.

10. The electronic latch assembly of claim 9, wherein the required energy threshold level is based on at least one of the backup supply voltage of the backup energy source or abackup supply capacitance of the backup energy source.

11. A method of operating an electronic latch assembly for a closure panel of a motor vehicle, the method comprising the steps of:
supplying power to the electronic latch assembly using a backup energy source having a backup supply voltage during a failure operating condition different from a normal operating condition, an electric motor controllable to drive an actuator group to latching and unlatching of the closure panel being supplied by a main power source of the motor vehicle providing a main supply voltage in the normal operating condition; and
supplying a power release voltage to the electric motor to unlatch the closure panel, the power release voltage adjusted to different levels.

12. The method of claim 11, wherein the power release voltage is adjusted based on characteristics of the backup energy source.

13. The method of claim 12, wherein the characteristics of the backup energy source 20 include the backup supply voltage and the method further includes the step of adjusting the power release voltage based the backup supply voltage.

14. The method of claim 12, wherein the characteristics of the backup energy source include a backup supply capacitance and the method further includes the step of adjusting the power release voltage based the backup supply capacitance.

15. The method of claim 11, wherein the power release voltage is adjusted based on the unlatching being completed.

16. The method of claim 11, wherein the power release voltage includes a first power release voltage and a second power release voltage greater than the first power release voltage and the method further includes the steps of:
supplying the first power release voltage to the electric motor to unlatch the closure panel;
determining whether the unlatching of the closure panel is completed using the first power release voltage; and
supplying the second power release voltage to the electric motor to unlatch the closure panel in response to determining the unlatching is not completed using the first power release voltage.

17. The method of claim 16, wherein the second power release voltage is a maximum power release voltage that the backup energy source is capable of providing.

18. The method of claim 11, wherein the power release voltage includes a first power release voltage and a maximum power release voltage the backup energy source is capable of providing and the method further includes the steps of:
determining whether the backup energy source is capable of supplying the electric motor for a predetermined quantity of unlatching attempts; and
supplying the electric motor with the maximum power release voltage in response to determining the backup energy source is not capable of supplying the electric motor for the predetermined quantity of unlatching attempts.

19. The method of claim 11, wherein the power release voltage includes a first power release voltage and a second power release voltage greater than the first power release voltage and the method further includes the steps of:
receiving a request for unlatching during the failure operating condition;
determining whether a backup energy level of the backup energy source is greater than a required energy threshold level;
supplying the second power release voltage to the electric motor to unlatch the closure panel in response to determining the backup energy level of the backup energy source is not greater than the required energy threshold level;
ending the unlatching after supplying the second power release voltage to the electric motor to unlatch the closure panel;
supplying the first power release voltage to the electric motor to unlatch the closure panel in response to determining the backup energy level of the backup energy source is greater than the required energy threshold level;
determining whether the unlatching of the closure panel is completed using the first power release voltage;
ending the unlatching in response to determining the unlatching is completed using the first power release voltage;
supplying the second power release voltage to the electric motor to unlatch the closure panel in response to determining the unlatching is not completed using the first power release voltage; and
ending the unlatching.

20. The method of claim 19, wherein the required energy threshold level is based on at least one of the backup supply voltage of the backup energy source or abackup supply capacitance of the backup energy source.
